(19) United States
(12) Patent Application Publication
(10) Pub. No.: US 2004/0086306 A1
(43) Pub. Date: May 6, 2004

(54) Image forming apparatus

(76) Inventors: Kazuhisa Edahiro, Osaka (JP); Takashi Miyake, Osaka (JP); Motoki Moriguchi, Osaka (JP); Hiroshi Kusumoto, Osaka (JP); Keiji Itsukushima, Osaka (JP)

Correspondence Address: BIRCH STEWART KOLASCH & BIRCH, PO BOX 747, FALLS CHURCH, VA, 22040-0747, US

(21) Appl. No.: 10/462,781

(22) Filed: Jun. 17, 2003

(30) Foreign Application Priority Data
Jun. 17, 2002 (JP) 2002-175901

(51) Int. Cl. G03G 15/20

(52) U.S. Cl. 399/328

(57) ABSTRACT

An image forming apparatus includes a fusing device comprising of a fuser roller, which fuses toner on a sheet of paper, and a pressure roller getting into contact with the fuser roller to form a nip between them where the sheet of paper passes through. A fuser-side external heat roller having an internal heater comes into contact with the fuser roller. A pressure-side heat roller having an internal heater comes into contact with the pressure roller. The fuser roller and the pressure roller have approximately same outer diameter and are both composed of an elastic material. An approximate radius of the nip formed between the two rollers is set to be equal to or larger than a radius of the fuser roller or the pressure roller. In another construction, the rollers are different in outer diameter, but each composed of an elastic material and a nip between them is set to be equal to or larger than 1.25 times as large as the radius of either the fuser roller or the pressure roller with smaller outer diameter.

### BACKGROUND OF THE INVENTION

1. Field of the Invention

The present invention relates to an image forming apparatus provided with a fusing device which fuses a toner image on a sheet of paper by letting the sheet of paper carrying a toner image pass through a nip formed between a pair of heated rollers to heat and fuse the toner on the sheet of paper.

2. Description of the Prior Art

In an xerographic image forming apparatus, a toner image formed on a sheet of paper is fused using a heat roller. At least one of a pair of nip-forming rollers is provided with an internal heat source. The internal heat source heats the roller, and the roller then heats a sheet of paper passing through the nip to fuse a toner image on the sheet of paper.

In a conventional heat roller fusing device, heat capacity of a fusing roller is rather large that it takes time to heat the fusing roller surface to an appropriate temperature range by transmitting heat generated by an internal heat source, for example, a halogen lamp. Therefore, after a power switch of the image forming apparatus is turned on, users have to wait until the roller surface becomes hot enough for fusing, or in other words, reaches the fusing temperature. This warming-up process takes several minutes and significantly deteriorates the efficiency of office work.

If an energy-saving mode is established in the image forming apparatus, the surface temperature of the fuser roller is lowered after fusing process. Also in this case, it takes time for the fuser roller to resume the fusing temperature. If the fuser roller surface temperature is lowered only slightly to quicken the resumption of the fusing temperature, favorable energy-saving effects cannot be expected.

Furthermore, in a full-color image forming apparatus, it is necessary to control not only the surface temperature of a fuser roller but also that of a pressure roller in order to keep them within a predetermined temperature range, so that the gloss of a color image is maintained stably within a desired range. For this purpose, it is common to provide an internal heat source like halogen lamp in both the fuser roller and the pressure roller. However, total energy consumption of the image forming apparatus should be kept within a specific range. This limitation forces the power allotted to the fuser roller in a full-color image forming apparatus be smaller than the one in an image forming apparatus in which only the fuser roller is provided with an internal heat source. As a result, in a full-color image forming apparatus, the warming-up process and the resumption process from the energy-saving mode take more time than in a monochrome image forming apparatus.

In order to shorten the warming-up time and decrease the power consumption, a heat roller fusing device in which a fusing roller is heated with an external heat source is proposed. Japanese Patent Application Laid-Open 2001-343860 shows this kind of device, which in this specification is shown in FIG. 16. In the device of FIG. 16, a nip is formed between a fuser roller 151 and a pressure roller pressed to the fuser roller. A heat roller 153 with an internal heat source comes into contact with the fuser roller 151 to heat it from the outside. This construction is suitable for heat transferring to the surface of the fuser roller. However, it has the following disadvantages.

First, according to a construction example, the fuser roller 151 has an aluminum core 151a, its outer diameter is 50 mm and its thickness is 3 mm, and its outer surface is surrounded by a heat insulating layer 151b of 4 mm thickness. Having a metal core as its main element, this construction often leads a full-color image of excessive gloss with unstable gloss level.

Secondly, according to a construction example, a pressure roller 152 has an steel core 152a, its outer diameter is 50 mm and its thickness is 4 mm, and its outer surface is surrounded by an elastic layer 152b of 5 mm thickness. In this construction, the pressure roller 152 is regarded as an elastic roller. As the fuser roller 151 is mainly composed of a metal roller while the pressure roller 152 is mainly composed of an elastic roller, the convex line of the nip bulges toward the pressure roller 152. As a result, a sheet of paper P curls around the fuser roller 151 with a significant degree. If a toner image carried on a sheet paper is full-color and contains large amount of toner, paper curling may cause many troubles. In some occasions, incomplete separation of the sheet of paper P or jamming at the fusing device may occur. A separation claw can be installed as a countermeasure to prevent above problems. However, the separation claw leaves a scraping mark and damages the quality of image on the sheet of paper P.

Thirdly, since the heat from a heat roller 153 is transferred indirectly to the surface of the pressure roller 152 by way of the fuser roller 151, it takes time for the pressure roller 152 to gain designated surface temperature. This leads to problems such as prolongation of the warming-up time and unsatisfactory fusing.

### SUMMARY OF THE INVENTION

It is the principal object of the present invention to provide an image forming apparatus which can shorten the warming-up process significantly. It is also an object of the present invention to avoid the formation of a nip that is excessively convex and prevent curling and incomplete separation of a sheet of paper that passes through the nip.

In order to achieve the above-mentioned object, in accordance with the present invention, an image forming apparatus is provided with a fusing device comprising: a fuser roller for fusing a toner image on a sheet of paper; a fuser-side external heating means for heating the fuser roller from an outside; a pressure roller getting into contact with the fuser roller to form a nip between them through which the sheet of paper passes; wherein the fuser roller and the pressure roller have approximately a same outer diameter and are both composed of an elastic material; and an approximate radius of the nip is set to be equal to or larger than 1.25 times as large as the radius of the fuser roller or the pressure roller. According to this construction, as the fuser roller and the pressure roller are of proximately the same diameter and are both composed of an elastic material, and the approximate radius of the nip is set to be equal to or larger than 1.25 times as large as the radius of the fuser roller or the pressure roller, the nip does not become excessively convex toward either of the two rollers, and curling and incomplete separation of the sheet of paper can be avoided.

In accordance with the present invention, an image forming apparatus is provided with a fusing device comprising: a fuser roller for fusing a toner image on a sheet of paper; a fuser-side external heating means for heating the fuser roller from an outside; a pressure roller getting into contact with the fuser roller to form a nip between them through which the sheet of paper passes; wherein the fuser roller and the pressure roller have different outer diameters and are both composed of an elastic material; and an approximate radius of the nip is set to be equal or larger than 1.25 times as large as the radius of either the fuser roller or the pressure roller with smaller outer diameter. According to this construction, as the fuser roller and the pressure roller have different outer diameters and are both composed of an elastic material, and the approximate radius of a nip formed between these two rollers is set to be equal or larger than 1.25 times as large as the radius of either the fuser roller or the pressure roller with smaller outer diameter, the nip does not become excessively convex toward either of the two rollers, and curling and incomplete separation of the sheet of paper can be avoided.

In accordance with the present invention, in an image forming apparatus described above, the pressure roller has a smaller outer diameter than the fuser roller. In this construction, the convex line of the nip forms a large-diameter arc bulging from the pressure roller toward the fuser roller. As a result, the tip of the paper passing through the nip comes out downward toward the pressure roller to make sure that the sheet of paper does not curl upward and is not caught on the fuser roller but move smoothly.

In accordance with the present invention, in the image forming apparatus mentioned above, a convex line of the nip bulges toward the fuser roller. This construction makes the sheet of paper tend to curl around the pressure roller, and prevents incomplete separation of the sheet of paper and jamming at the fusing device.

In accordance with the present invention, in the image forming apparatus mentioned above, the fuser-side external heating means includes a fuser-side heat roller having an internal heat source for heating the fuser roller by getting into contact with a fuser roller surface. This construction makes the fuser roller surface evenly heated by the heat from the fuser-side heat roller.

In accordance with the present invention, in the image forming apparatus mentioned above, a plurality of fuser-side heat rollers are provided. This construction significantly shortens the warming-up time for the fuser roller.

In accordance with the present invention, in the image forming device mentioned above, the elastic material composing the pressure roller has a higher hardness than the elastic material composing the fuser roller. This construction ensures formation of a convex nip surface bulging toward the fuser roller. This is certain even when the outer diameters of the fuser and pressure rollers are equal.

In accordance with the present invention, in the image forming apparatus mentioned above, the fuser roller is not provided with a separation claw which comes into contact with the fuser roller. This construction avoids a scraping mark made by a separation claw being left in an image on a sheet of paper. Also, elimination of a separation claw reduces the total number of components and leads to reduction in cost.

In accordance with the present invention, in the image forming apparatus mentioned above, the pressure roller is provided with a pressure-side external heating means which heats the pressure roller from an outside. In this construction, not only the fuser roller is heated with the fuser-side external heating means, but also the pressure roller is heated with the pressure-side external heating means, thereby the warming-up time is significantly shortened.

In accordance with the present invention, in the image forming device mentioned above, the pressure-side external heating means comprises a pressure-side heat roller having an internal heat source for heating the pressure roller by getting into contact with a pressure roller surface. This construction makes the pressure roller surface evenly heated by the heat from the pressure-side heat roller.

### DESCRIPTION OF THE DRAWINGS

These and other objects and features of the present invention, in accordance with the preferred embodiment, are more particularly described in the following detailed description, taken in conjunction with the preferred embodiments with reference to the accompanying drawings in which:

FIG. 1 is an exemplary vertical section of a printer in accordance with a first embodiment of the present invention;

FIG. 2 is an exemplary vertical section of an image forming unit of the printer;

FIG. 3 is an exemplary vertical section of a roller construction of the fusing unit of the printer;

FIG. 4 is an exemplary vertical section showing the relationship between a roller radius and an approximate nip radius;

FIG. 5 is an exemplary vertical section similar to FIG. 3 in accordance with a second embodiment of the present invention;

FIG. 6 is a first table showing conditions and results of examples of working;

FIG. 7 is a second table showing conditions and results of examples of working;

FIG. 8 is an exemplary vertical section showing a situation in which a nip bulges toward a fuser roller;

FIG. 9 is a table showing conditions to realize the situation indicated in FIG. 8 as well as results caused from the conditions;

FIG. 10 is an exemplary vertical section showing a situation in which a nip bulges toward a pressure roller;

FIG. 11 is a table showing conditions to realize the situation indicated in FIG. 10 as well as results caused from the conditions;

FIG. 12 is a front view of the outline of a roller configuration;

FIG. 13 is a front view showing a state of an assembly of a fuser roller and a pressure roller;

FIG. 14 is an exemplary vertical section similar to FIG. 3 in accordance with a third embodiment of the present invention;

FIG. 15 is an exemplary vertical section similar to FIG. 3 in accordance with a fourth embodiment of the present invention;

FIG. 16 is an exemplary vertical section showing a conventional roller construction of a fusing unit.

### DESCRIPTION OF THE PREFERRED EMBODIMENTS

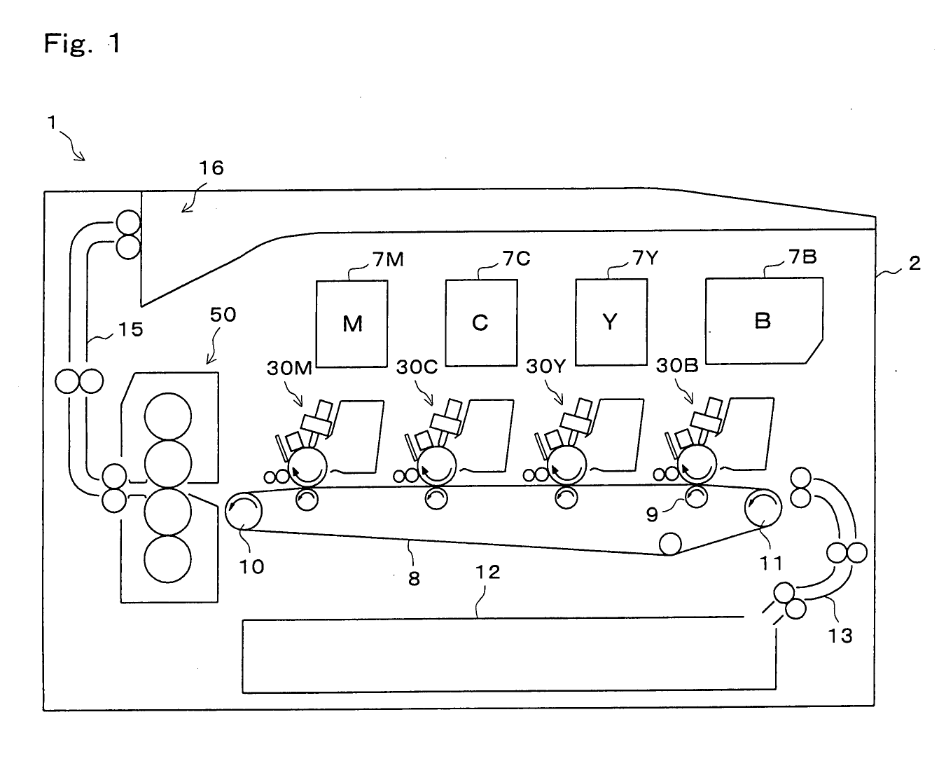

Referring now to FIGS. 1 through 4, 12 and 13, a first embodiment of the present invention will be described.

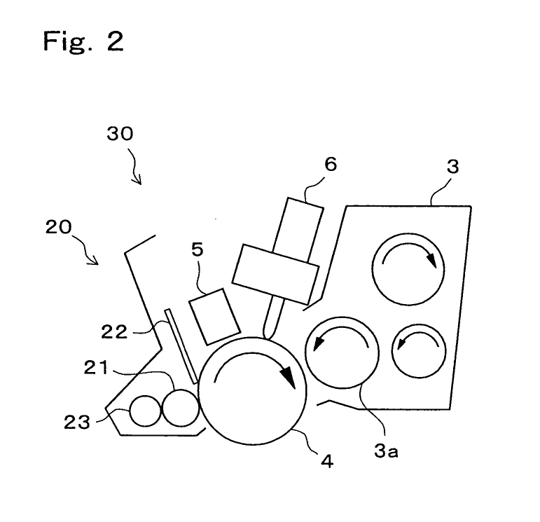

FIG. 1 is an exemplary vertical section of a tandem-style color printer 1, an example of xerographic image forming device. FIG. 2 is an exemplary vertical section of its image forming unit.

In the printer 1, either of full-color image output or monochrome image output is selected, in response to the color information of the original image data sent from an external computer. Either the image is full-color or monochrome, the image output rate is set to be twenty (20) sheets per minute, with the sheet being A4 size paper. Apart from the image output rate, concrete values of various parameters such as dimension, ratio, speed, voltage, and temperature will show up hereinafter. These figures are mere examples and should not be considered to limit the scope of the present invention.

A paper conveyor belt 8 is placed inside a housing 2 of the printer 1. The paper conveyor belt 8 is wound around pulleys 10 and 11 and transports sheets of paper horizontally from the right to the left in FIG. 1. On a paper receiving side of the paper conveyor belt 8, a paper feeder 12 and a paper-conveying path 13 are provided. On a paper exit side of the paper conveyor belt 8, a fusing unit 50, a paper-conveying path 15 and a paper-stacking space 16 are provided. The paper-stacking space 16 is located on the top of the housing 2.

Four (4) image forming units are placed above the paper conveyor belt 8 in series from an upstream side to a downstream side in the paper transport direction. Four image forming units are, from the upstream side, an image forming unit 30B for black tone, an image forming unit 30Y for yellow tone, an image forming unit 30C for cyan tone and an image forming unit 30M for magenta tone.

Construction of the image forming units 30B, 30Y, 30C and 30B is shown in FIG. 2. Since all of the image forming units have a common construction, the identification letters “B,” “Y,” “C” and “M” are omitted only to leave the number “30.”

The key part of the image forming unit 30 is a photosensitive drum 4 with photoconductive layer of amorphous silicone. Around the photosensitive drum 4, a main electrostatic-charger 5, an LED print head unit 6, a development unit 3 and a cleaning unit 20 are disposed. Also, as shown in FIG. 1, a transfer roller 9 is disposed opposite to the photosensitive drum 4 below the paper conveyor belt 8. The transfer roller 9 supports the paper conveyor belt 8 to make it come into close contact with the photosensitive drum 4. A voltage of −1.5 kV is applied to the transfer roller 9.

The development unit 3 contains developer which is a mixture of black, yellow, cyan or magenta toners with ferrite carrier by the weight ratio of 5:95. The toner particles have median diameter of 9 μm (on the volume basis) by Counter Counter measurement and the ferrite carrier particles have the average particle diameter of 70 μm. The development unit 3 is provided with a development sleeve 3a, which contains a built-in permanent magnet (not shown in the figure).

The photosensitive drum 4 and the development sleeve 3a are disposed opposite to each other, with a gap of 0.5 mm between them, and rotate in a manner that their confronting surfaces move in the same direction. Linear velocity at the periphery of the photosensitive drum 4 is 100 mm/sec while that of the development sleeve 3a is 200 mm/sec. A magnetic brush is formed on the surface of the development sleeve 3a by the developer. Toner particles are charged positively through friction against carrier particles. A developer leveling plate, which is not shown in the figure, is provided to the development sleeve 3a. The gap between the developer leveling plate and the development sleeve 3a is 0.5 mm. Development bias voltage of +300V is applied to the development sleeve 3a.

The developer in the development unit 3 is consumed during development process. In order to replenish the consumed developer, toner supply containers 7B, 7Y, 7C and 7M are provided, corresponding to the image forming units 30B, 30Y, 30C and 30M, to supplement the developer via a transport means which is not shown in the figure. In consequence, the development unit 3 can always contain an appropriate amount of developer therein.

The cleaning unit 20 includes a cleaning roller 21 made of rubber which comes into contact with the photosensitive drum 4; a cleaning blade 22 which scrapes residual toner from the photosensitive drum 4; and a purge screw 23 to drive the residual toner into a dump container which is not shown in the figure. The casing of the cleaning unit 20 is not shown in FIG. 1.

The printer 1 performs image forming in the following manner:

The surface of the photosensitive drum 4 is evenly charged to +400V by the main electrostatic-charger 5. When copy image data are input from an external computer, the LED print head 6 discharges light beam corresponding to the copy image data toward the surface of the photosensitive drum 4. When a spot in the surface of the photosensitive drum 4 is exposed to the light beam, the voltage at the spot is reduced to +25V at maximum. The voltage variation from +400V at non-exposed spot to +25V at exposed spot forms an electrostatic latent image on the surface of the photosensitive drum 4. Positively charged toner particles in the developer stick to the exposed spot by a development bias voltage of +300V applied to the development sleeve 3a, and the electrostatic latent image becomes visible by the toner particles.

The paper conveyor belt 8 moves in the same direction of the movement of the surface of the photosensitive drum 4, at 100 mm/sec, just the same speed as the linear velocity of the periphery of the photosensitive drum 4 to convey sheets of paper supplied by the paper feeder 12. Exposure timing of the photosensitive drum 4 by the LED print head 6 is set in a manner that the toner transfer starts at a specified point on a sheet of paper.

When a sheet of paper on the paper conveyor belt 8 passes under the photosensitive drum 4, the toner particles stuck to the photosensitive drum 4 are attracted toward the sheet of paper by the voltage of −1.5 kV applied to the transfer roller 9. This causes toner transfer to the sheet of paper.

The residual toner particles are scraped off from the photosensitive drum 4 by the cleaning blade 22, and driven into a dump container not shown in the figure, by the purge screw 23. The cleaning roller 21 reconditions the surface of the photosensitive drum 4 after toner transferring.

Each of black, yellow, cyan and magenta toners is transferred to a sheet of paper sequentially at the image forming units 30B, 30Y, 30C and 30M. The sheet of paper on which a color image is formed by toners is pulled into the fusing unit 50 from the paper conveyor belt 8. Then the sheet of paper is fused the toner image by a heat roller in the fusing unit 50, and goes through the paper-conveying path 15 up to the paper-stacking space 16.

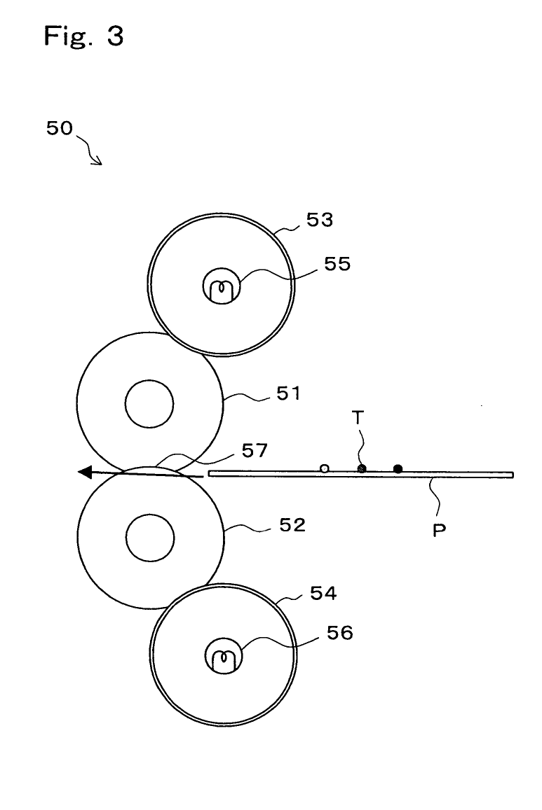

FIG. 3 is an exemplary vertical section showing the construction of the rollers in the fusing unit 50. The fusing unit 50 is provided with four (4) rollers in total, including a fuser roller 51 and a pressure roller 52, between which a nip for fusion is formed by being pressed each other; a fuser-side heat roller 53 which comes into contact with the fuser roller 51;.and a pressure-side heat roller 54 which comes into contact with the pressure roller 52.

A heater 55, as a heat source, is installed inside the fuser-side heat roller 53, and a heater 56, as s heat source, is installed inside the pressure-side heat roller 54. When either of the fuser roller 51 and the fuser-side heat roller 53 rotates, the other follows, and the periphery of the fuser roller 51 is evenly heated by the fuser-side heat roller 53. In the same way, either of the pressure roller 52 and the pressure-side heat roller 54 rotates, the other follows, and the periphery of the pressure roller 52 is evenly heated by the pressure-side heat roller 54. A toner T on a sheet of paper P which passes through a nip 57 formed between the fuser roller 51 and the pressure roller 52 is heated by the heat of the fuser roller 51 or by the heat of both of the fuser roller 51 and the pressure roller 52, and melted to be fused on the sheet of paper P.

The outer diameter of the fuser roller 51 and that of the pressure roller 52 are approximately same, and the peripheral portion of each roller is formed of an elastic material. The approximate radius of a nip 57 formed between the fuser roller 51 and the pressure roller 52 is set to be equal to or larger than 1.25 times as large as the radius of the fuser roller 51(namely, the radius of the pressure roller 52).

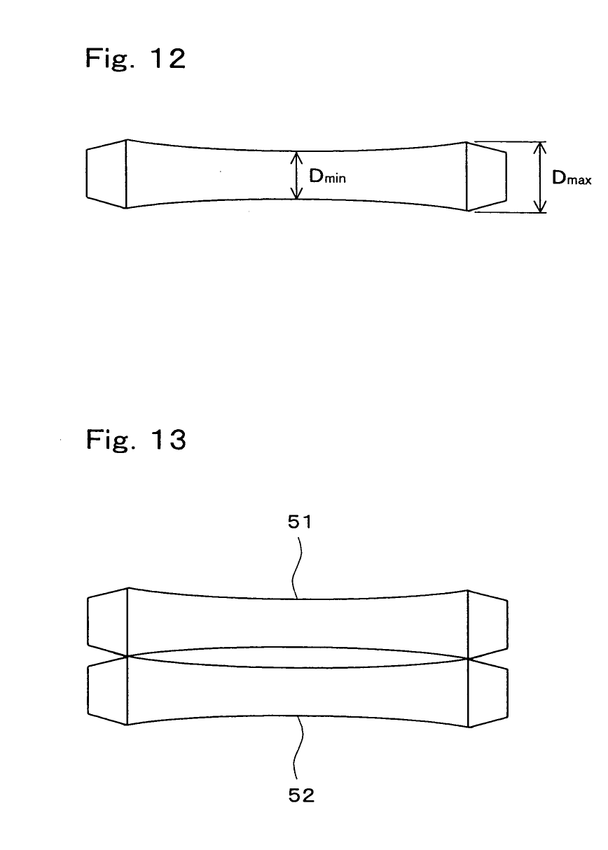

In order to prevent a sheet of paper from being wrinkled due to pressure applied by the nip, the fuser roller 51 has a configuration formed in an inverted crown shape as shown in FIG. 12. In other words, the diameter of the fuser roller 51 is slightly smaller in the center than on both ends. The maximum diameter Dₘₐₓ herein is set to be 25 mm and the minimum diameter Dₘᵢₙ is set to be smaller than Dₘₐₓ by 0.3 mm. The difference between the maximum diameter and the minimum diameter depends on characteristics of the elastic material and the roller diameter, and may come to be 0.5 mm at the maximum.

The pressure roller 52 is shaped in a straight pipe, or an inverted crown in the same manner as the fuser roller 51. FIG. 13 shows a combination of the fuser roller 51 and the pressure roller 52, both of which are shaped in an inverted crown.

The approximate radius of the nip 57 is measured in the maximum diameter portion of the roller. The “approximate radius” herein means a radius of an arc, which is geometric representation of the convex line of the nip 57. The “approximate radius” is measured by taking a photograph of the nip between the fuser roller 51 and the pressure roller 52 from the roller end side, and drafting the curve in the photograph on a sheet of paper. As mentioned above, the fuser roller 51 or both of the fuser roller 51 and the pressure roller 52 are shaped in an inverted crown and a photograph of the nip between the rollers in this inverted crown shape is taken. The same procedure is applied to a second, a third, and a fourth embodiments of the present invention.

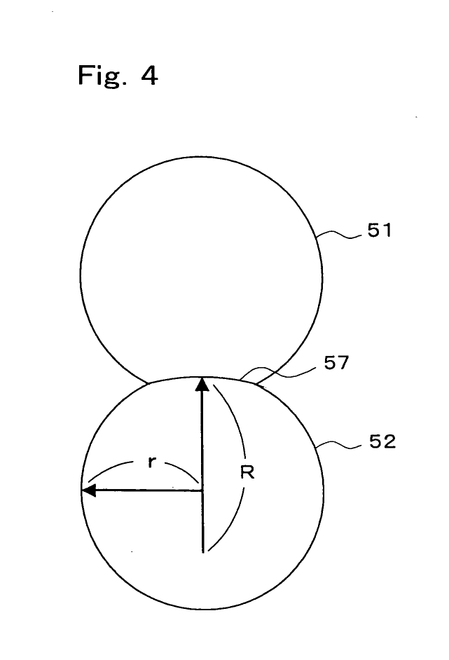

FIG. 4 is an exemplary vertical section showing the relationship between the radius of a roller and the approximate radius of a nip. When the roller radius is r and the approximate radius of the nip 57 is R, they are set to be R≧1.25r.

The elastic material of the fuser roller 51 and that of the pressure roller 52 may be made of either the same material or different material as long as the approximate radius of the nip 57 is equal to or larger than 1.25 times as large as the radius of the fuser roller 51 or the pressure roller 52.

It is desirable that the fuser roller 51 and the pressure roller 52 are of a construction including a metal core, a sponge layer and a release layer. However, this construction is not compulsory. Various constructions are available. For example, a metal core can be combined with a rubber layer of low heat capacity and a release layer, or with a sponge layer and a rubber (or metal) layer and a release layer.

In this way, by heating the fuser roller 51 with the fuser-side heat roller 53 and the pressure roller 52 with the pressure-side heat roller 54, the warming-up time is significantly shortened. Furthermore, since the approximate radius of the nip 57 between the fuser roller 51 and the pressure roller 52 is set to be equal to or larger than 1.25 times as much as the radius of the fuser roller 51 or the pressure roller 52, the nip 57 does not become extremely convex toward either of the rollers, curling of a sheet of paper P is restrained, and incomplete separation of a sheet of paper comes to be rare occasion.

Since incomplete separation of a sheet of paper is prevented as mentioned above, it is not necessary to attach a separation claw to a fixed member in the fusing unit 50 and have it come into contact with the fuser roller 51. The separation claw thus can be eliminated, resulting in reduction of component number and cost saving.

It is desirable that the convex line of the nip 57 bulges toward the fuser roller 51, in other words, the nip 57 should curve to form a convex curve bulging toward the fuser roller 51. By this construction, a sheet of paper P has a curling tendency to become convex on the side of the fuser roller 51 and become concave on the side of the pressure roller 52. The tip of the sheet of paper P exiting the nip 57 proceeds downward and will not be caught on the fuser roller 51. The separation claw becomes less necessary.

It is desirable that the elastic material used in the pressure roller 52 is harder than the counterpart in the fuser roller 51. Thus constructed, the convex line of the nip 57 is sure to bulge toward the fuser roller 51.

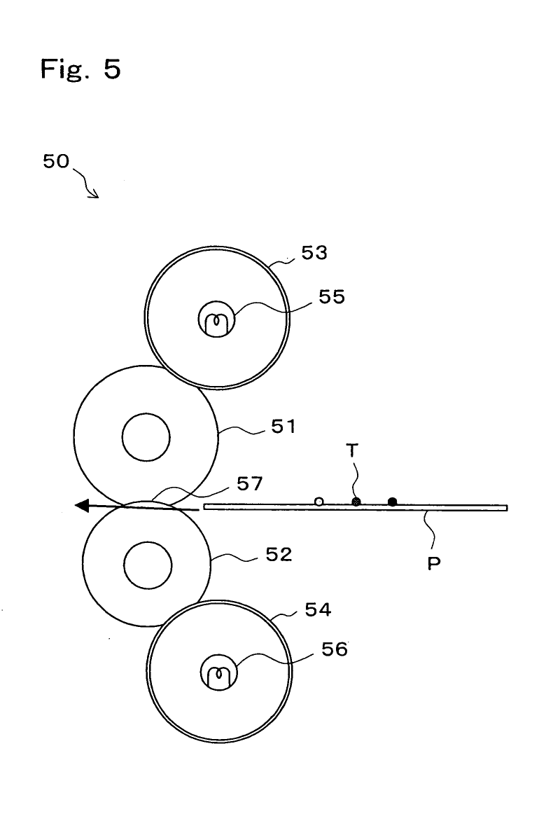

FIG. 5 is an exemplary vertical section similar to FIG. 3 showing a second embodiment of the present invention. The second embodiment also includes the fuser roller 51 and the pressure roller 52 which are pressed to each other to form a nip for fusion between them, a fuser-side heat roller 53 which comes into contact with the fusion roller 51, and a pressure-side heat roller 54, which comes into contact with the pressure roller 52. The outer diameter of the pressure roller 51 and that of the pressure roller 52 are not equal. Namely, the pressure roller 52 has a smaller diameter than the fuser roller 51.

The outer layer of either of the fuser roller 51 and the pressure roller 52 is composed of elastic material. The approximate radius of the nip 57 formed between the fuser roller 51 and the pressure roller 52 is set to be equal to or larger than 1.25 times as large as the radius of the pressure roller 52, which is smaller in diameter.

The elastic material used in the fuser roller 51 and that of the pressure roller 52 may be made of either the same material or different material, as long as the approximate radius of the nip 57 is equal to or larger than 1.25 times as larges as the radius of the pressure roller 52.

It is desirable that the fuser roller 51 and the pressure roller 52 are of a construction including a metal core, a sponge layer and a release layer. However, this construction is not compulsory. Various constructions are available. For example, a metal core can be combined with a rubber layer of low heat capacity and a release layer, or with a sponge layer and a rubber (or metal) layer and a release layer.

In the same manner as the first embodiment of the present invention, by heating the fuser roller 51 with the fuser-side heat roller 53 and the pressure roller 52 with the pressure-side heat roller 54, the warming-up time is significantly shortened. Furthermore, since the approximate radius of the nip 57 between the fuser roller 51 and the pressure roller 52 is set to be equal to or larger than 1.25 times as much as the radius of the pressure roller 52, the nip 57 does not become extremely convex toward either of the rollers, curling of a sheet of paper P is restrained, and incomplete separation of a sheet of paper comes to be rare occasion.

Since incomplete separation of a sheet of paper is prevented as mentioned above, it is not necessary to attach a separation claw to a fixed member in the fusing unit 50 and have it come into contact with the fuser roller 51. The separation claw thus can be eliminated, resulting in reduction of component number and cost saving.

It is desirable that the convex line of the nip 57 bulges toward the fuser roller 51, in other words, the nip 57 should curve to form a convex curve bulging toward the fuser roller 51. By this construction, a sheet of paper P has a curling tendency to become convex on the side of the fuser roller 51 and become concave on the side of the pressure roller 52. The tip of a sheet of paper P exiting the nip 57 proceeds downward and will not be caught on the fuser roller 51. The separation claw becomes less necessary.

In the second embodiment of the present invention, since the pressure roller 52 has a smaller diameter than the fuser roller 51, when the elastic materials of both rollers are of the same kind, the nip 57 bulges from the pressure roller 52 to the fuser roller 51, forming a large diameter arc. As a result, the tip of the sheet of paper P passing through the nip 57 comes out downward toward the pressure roller 52 to make sure that the sheet of paper P does not curl upward and is not caught on the fuser roller 51 but move smoothly.

When the elastic material used in the pressure roller 52 is harder than the counterpart in the fuser roller 51, along with the aforesaid difference in diameter, the convex line of the nip 57 is sure to bulge toward the fuser roller 51.

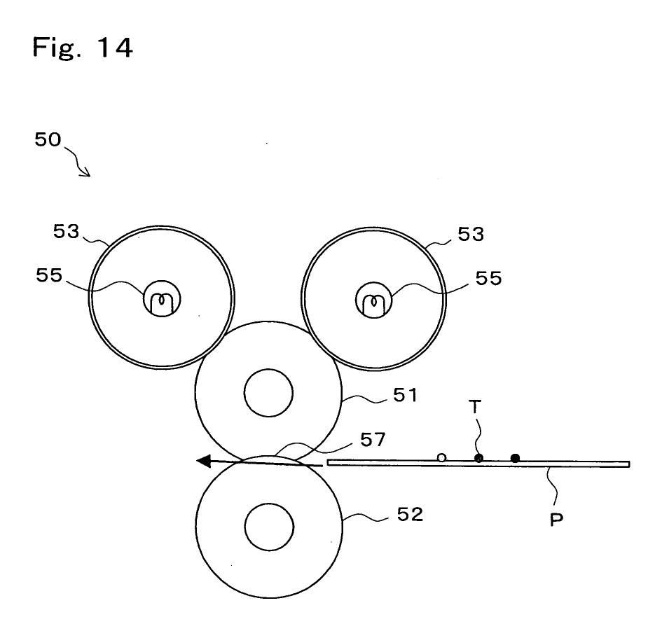

A third embodiment of the present invention is shown in FIG. 14. FIG. 14 is an exemplary vertical section similar to FIG. 3. In the same way as the first embodiment of the present invention, the third embodiment includes the fuser roller 51 and the pressure roller 52, both of which have peripheral portion formed of an elastic material, and the outer diameters of the rollers are approximately same. The approximate radius of the nip 57 formed between the fuser roller 51 and the pressure roller 52 is set to be equal to or larger than 1.25 times as large as the radius of the fuser roller 51(namely, the radius of the pressure roller 52). Different from the first embodiment of the present invention, however, the pressure roller 52 is not provided with a heat roller and the fuser roller 51 is provided with a plurality of fuser-side heat rollers 53 instead.

By heating the fuser roller 51 with a plurality of (in the figure, two) fuser-side heat rollers 53, the warming-up time is significantly shortened. In addition to this construction, the pressure roller 52 may also be provided with a pressure-side heat roller.

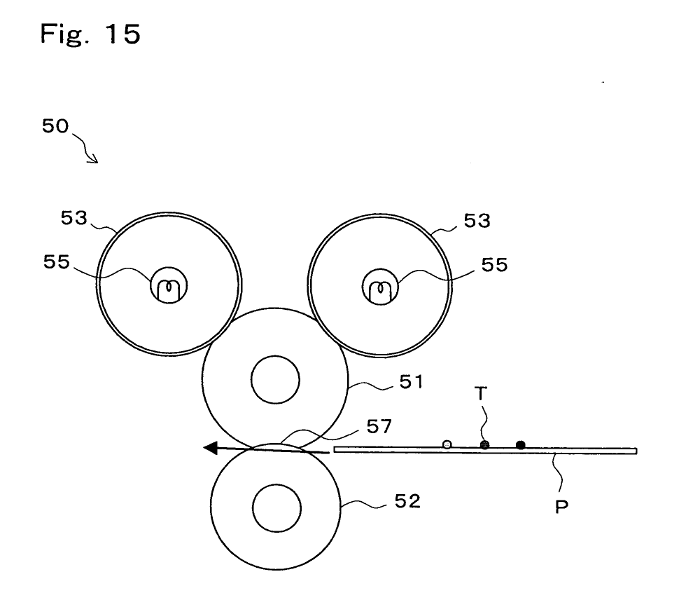

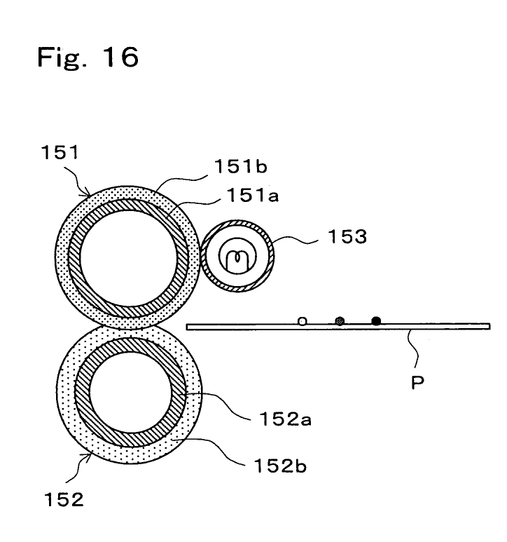

A fourth embodiment of the present invention is shown in FIG. 15. FIG. 15 is an exemplary vertical section similar to FIG. 3. In the same way as the second embodiment of the present invention, the fourth embodiment the fuser roller 51 and the pressure roller 52, both of which have peripheral portion formed of an elastic material, and the outer diameter of the pressure roller 51 and that of the pressure roller 52 are not equal. Namely, the pressure roller 52 has a smaller diameter than the fuser roller 51. The approximate radius of the nip 57 formed between the fuser roller 51 and the pressure roller 52 is set to be equal to or larger than 1.25 times as large as the radius of the pressure roller 52, which is smaller in diameter. Different from the second embodiment of the present invention, however, the pressure roller 52 is not provided with a heat roller and the fuser roller 51 is provided with a plurality of fuser-side heat rollers 53 instead.

By heating the fuser roller 51 with a plurality of (in the figure, two) fuser-side heat rollers 53, the warming-up time is significantly shortened. In addition to this construction, the pressure roller 52 may also be provided with a pressure-side heat roller.

While the first through the fourth embodiments of the present invention are related to a tandem-style full-color image forming device, the present invention is applicable to image forming devices of any other constructions.

Regarding the approximate radius of the nip 57, it is possible to make the diameter of the fuser roller 51 smaller than that of the pressure roller 52 in a manner that the approximate radius of the nip 57 is equal to or larger than 1.25 times as large as the radius of the fuser roller 51.

[Examples of Working of Invention] Examples of working of the present invention will be described hereinafter.

The paper feeding speed (process speed) of the image forming apparatus 1 is set at 120 mm/sec. Generally, from the viewpoint of heat conductivity and strength, a metal (aluminum or iron is recommendable for practical use) is used for heat rollers, whose surfaces are coated with a heat-resistant release material, such as PEA, PTEE and the like, as necessary. In this example, a hollow aluminum shaft of 20 mm in diameter and of 0.5 mm in wall thickness is used.

It is sufficient for a fuser roller to have heat capacity on its surface enough to sustain calorie to fuse a toner image on a sheet of paper. Therefore, rubber of low heat capacity, synthetic sponge, or a combination of rubber of low heat capacity or synthetic sponge with a thin layer of high heat conductivity and a heat-resistant release layer can be used to form a fuser roller. When intense heat is to be conducted, silicone rubber of high heat-conductivity, metal, silicone rubber with heat-conductive filler (e.g. metal), or the like, can be used.

In this example, a layer of silicone rubber foam of 6.5 mm thickness is formed on the surface of a metal shaft of 12 mm in diameter and its surface is coated with PFA tube of 50 μm thickness, wherein the nip between the heat roller and the fuser roller becomes approximately 6 mm wide and the width of the nip between the fuser roller and the pressure roller becomes about 6 to 7 mm.

When the ASKER C hardness of the fuser roller and that of the pressure roller are set to be the same, the approximate radius of the nip becomes equal to or larger than 1.25 times as large as the radius of the fuser roller or that of the pressure roller, as long as a load applied to both rollers is not small. When the load is small, the approximate radius of the nip becomes less than 1.25 times as larges as the radius of the fuser roller or that of the pressure roller, and curling or incomplete separation of a sheet of paper is prone to occur. When the ASKER C hardness is set to be 40 degrees for both of the fuser roller and the pressure roller and a load of 3 kgf is applied to one of the two rollers, the nip is almost flat but becomes slightly convex toward either of the upper or the lower roller.

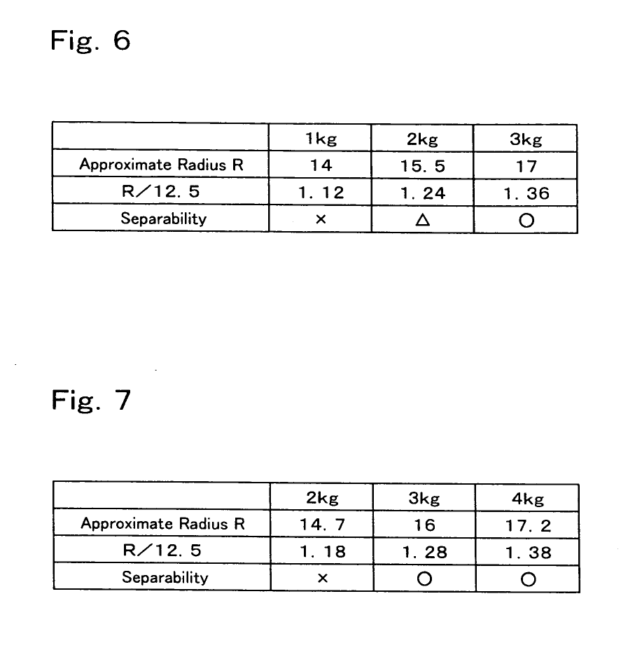

The approximate radius of this convex nip is 17 mm, which is 1.36 times as much as the roller radius of 12.5 mm. Almost no curling of a sheet of paper occurs and sufficient separation of a sheet of paper is achieved. However, when the load applied to one of the two rollers is 1 kgf, the approximate radius of the nip is 14 mm (which is 1.12 times as much as the roller radius), causing incomplete separation of a sheet of paper. These results are shown in the table in FIG. 6

When the pressure roller, which is in the lower position, has higher hardness than the fuser roller, which is in the higher position, for example, when the ASKER C hardness of the fuser roller is 40 degrees while that of the pressure roller is 50 degrees, application of pressure to the two rollers causes the nip to always become convex toward upward. However, since there is no large difference in hardness between the upper and the lower rollers, not only the fuser roller but the pressure roller, which has higher hardness, gets deformed, resulting in that the approximate radius of the nip is equal to or larger than 1.25 times as much as the radius of the roller.

The above-mentioned value can be achieved only when pressure of more than a specific value is applied. If the pressure is insufficient, the pressure roller is not sufficiently deformed. Therefore, in order to obtain the approximate radius of the nip equal to or larger than the values in the table in FIG. 6, based on the above-mentioned hardness, it is necessary to apply larger load than those in the table in FIG. 6. When the load on one of the two rollers is 3 kgf, the approximate radius of the nip is 16 mm, which is 1.28 times as much as the roller radius. This value is smaller than what is obtained when the load on one of the two rollers is 3 kgf in the table in FIG. 6, and it is the limit for separation. The results obtained when the ASKER C hardness of the fuser roller is 40 degrees while that of the pressure roller is 50 degrees are shown in the table in FIG. 7. When the difference in hardness between the fuser roller and the pressure roller is increased further, it becomes difficult to make the approximate radius of the nip equal to or larger than 1.25 times as large as the radius of the roller.

The above-mentioned example revealed that it is necessary to set the approximate radius of the nip formed between the fuser roller and the pressure roller to be equal to or greater than 1.25 times as large as the radius of the roller which is smaller in outer diameter of the two rollers.

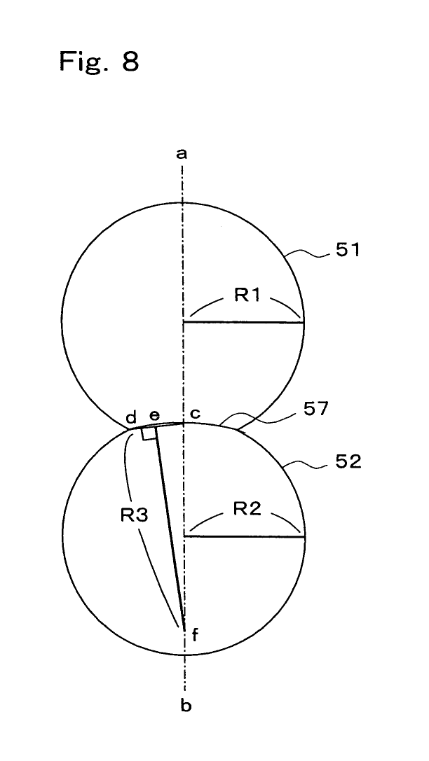

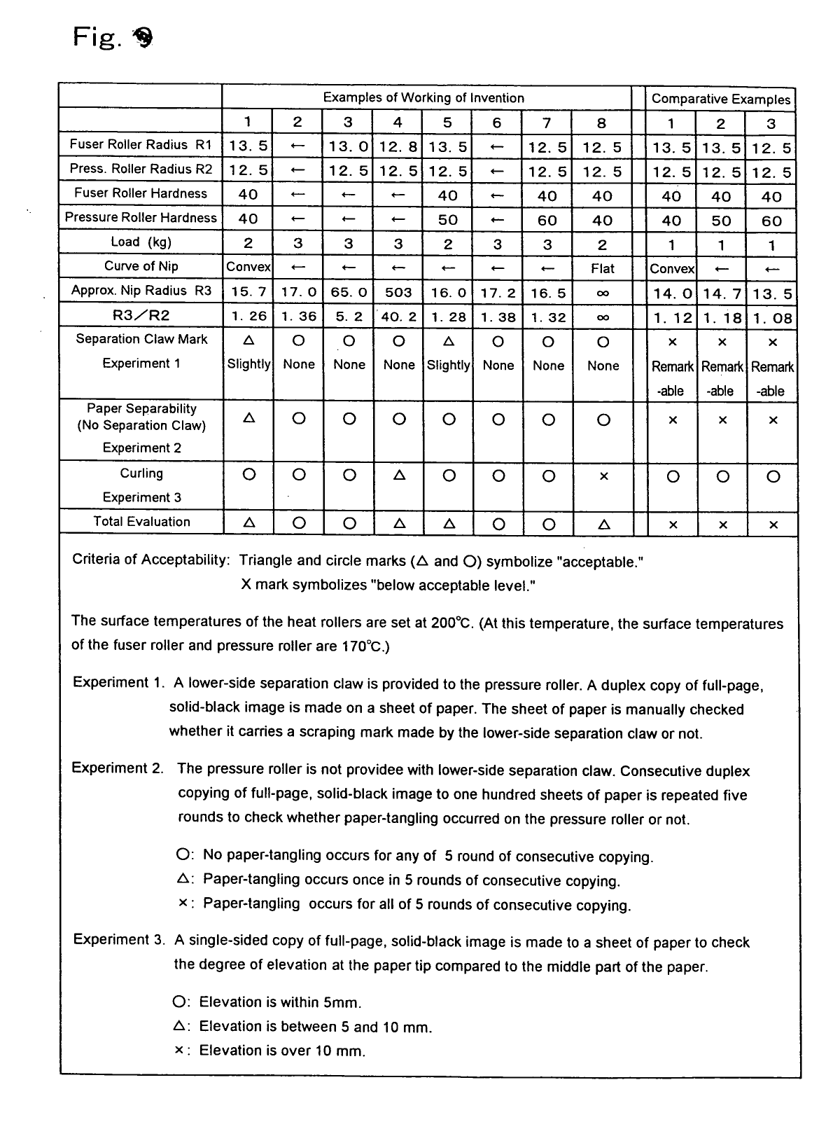

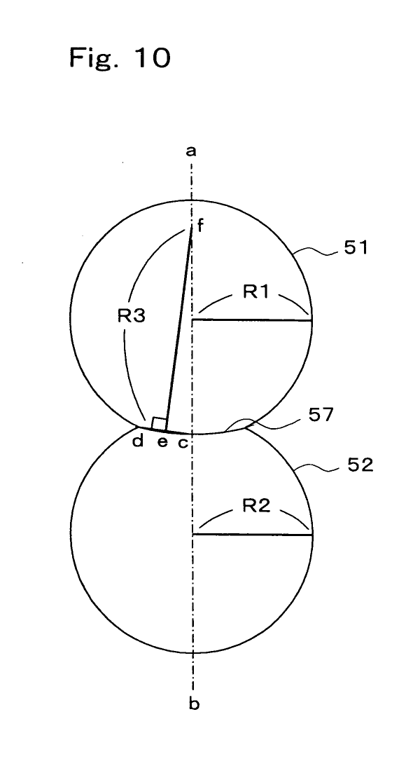

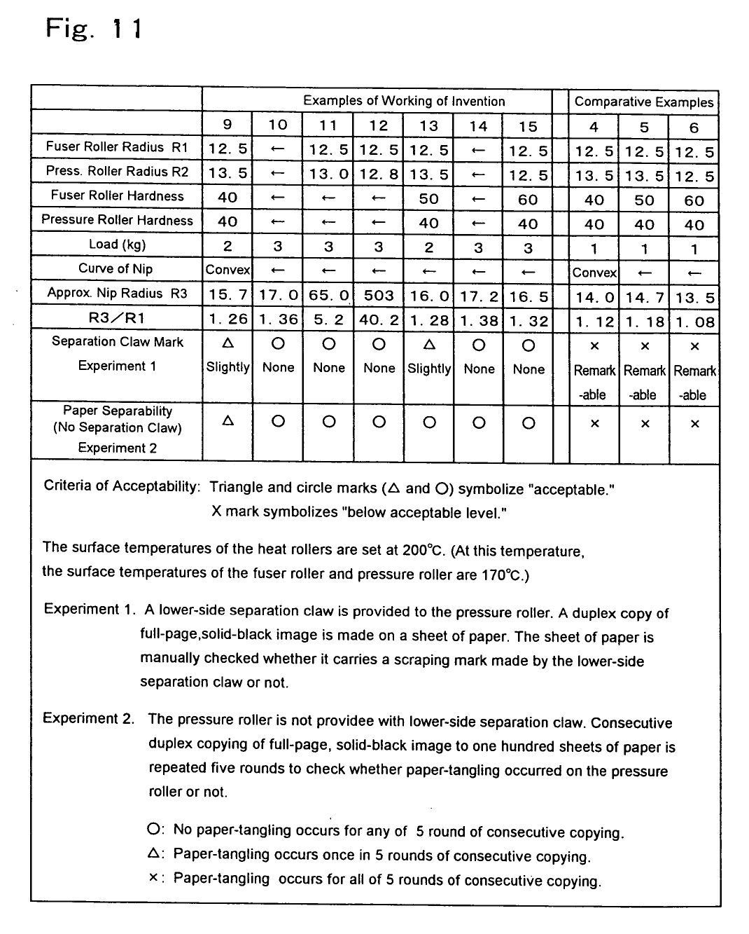

Other examples are shown in FIGS. 8 through 11. FIG. 8 is an exemplary vertical section showing the state wherein the pressure roller 52 has a smaller diameter than the fuser roller 51 to make the nip 57 bulging toward the fuser roller 51, and FIG. 9 shows a table of the conditions to realize the aforesaid state as well as the results brought from these conditions. FIG. 10 is an exemplary vertical section showing the state wherein the fuser roller 51 has a smaller diameter than the pressure roller 52 to make the nip 57 bulging toward the pressure roller 52, and FIG. 11 shows a table of the conditions to realize the aforesaid state as well as the results brought from these conditions.

FIG. 8 and FIG. 10 illustrate a method to obtain the approximate radius of the nip 57. First, a line segment “ab” passing through the center of the fuser roller 51 and that of the pressure roller 52 is drawn. Second, a normal line is drawn from a midpoint “e” of a line segment “cd,” which connects a point “c” where the line segment “ab” intersects the nip 57, and a point “d” on one end of the nip 57. An intersection point “f” of the normal line and the line segment “ab” is obtained. The distance between the midpoint “e” and the intersection point “f” constitutes an approximate radius R3 of the nip 57.

In Example 1 in FIG. 9, the radius R1 of the fuser roller 51 was set to be 13.5 mm while the radius R2 of the pressure roller 52 was set to be 12.5 mm. The ASKER C hardness was set to be 40 degrees for both the fuser roller 51 and the pressure roller 52. The load applied between the two rollers was 2 kgf on one side. The nip 57 curved to be convex, bulging toward the fuser roller 51, and the approximate radius R3 of the nip 57 was 15.7 mm. The ratio of the approximate radius R3 of the nip 57 to the radius R2 of the pressure roller 52, namely, R3/R2, was 1.26.

The surface temperature of the heat roller was set at 200° C., to make the surface temperature of the fuser roller 51 and that of the pressure roller 52 be 170° C.

On the above conditions, in Experiment 1, a lower-side separation claw was provided to the pressure roller 52. A duplex copy of full- page, solid-black image was made on a sheet of paper. The sheet of paper was then checked manually whether it carried a scraping mark made by the lower-side separation claw or not.

In Experiment 2, the pressure roller 52 was not provided with a lower-side separation claw. Consecutive duplex copying of full-page, solid-black image to one hundred sheets of paper was repeated five rounds to check whether paper-tangling occurred on the pressure roller 52 or not.

In Experiment 3, a single-sided copy of full-page, solid black image was made to a sheet of paper to check the degree of elevation at the paper tip compared to the middle part of the paper.

In Experiment 1, a slight scraping mark made by the lower-side-separation claw was observed on the sheet of paper. In Experiment 2, paper tangling occurred once in five rounds of consecutive copying. In Experiment 3, the elevation at the paper tip compared to the middle part of the paper was within 5 mm.

In Example 2 in FIG. 9, the radius R1 of the fuser roller 51 and the radius R2 of the pressure roller 52 were set to be the same as those of Example 1. The hardness of the fuser roller 51 and that of the pressure roller 52 were also set to be the same as those of Example 1. The load applied between the two rollers was 3 kgf on one side. The nip 57 curved to be convex, bulging toward the fuser roller 51. The approximate radius R3 of the nip 57 was 17.0 mm. The ratio of the approximate radius R3 of the nip 57 to the radius R2 of the pressure roller 52, namely, R3/R2, was 1.36.

Conditions of the surface temperature of the fuser roller 51 and the pressure roller 52 were set to be the same as those of Example 1. On the same conditions as Example 1, Experiment 1, 2 and 3 were performed.

In Experiment 1, no scraping mark made by the lower-side separation claw was observed on the sheet of paper. In Experiment 2, no paper tangling occurred for any of the five rounds of consecutive copying. In Experiment 3, the elevation at the paper tip compared to the middle part of the paper was within 5 mm.

In Example 3 in FIG. 9, the radius R1 of the fuser roller 51 was set to be 13.0 mm while the radius R2 of the pressure roller 52 was set to be 12.5 mm. The ASKER C hardness was set to be 40 degrees for both the fuser roller 51 and the pressure roller 52. The load applied between the two rollers was 3 kgf on one side. The nip 57 curved to be convex, bulging toward the fuser roller 51, and the approximate radius R3 of the nip 57 was 65.0 mm. The ratio of the approximate radius R3 of the nip 57 to the radius R2 of the pressure roller 52, namely, R3/R2, was 5.2.

Conditions of the surface temperature of the fuser roller 51 and the pressure roller 52 were set to be the same as those of Example 1. On the same conditions as Example 1, Experiment 1, 2 and 3 were performed.

In Experiment 1, no scraping mark made by the lower-side separation claw was observed on the sheet of paper. In Experiment 2, no paper tangling occurred for any of the five rounds of consecutive copying. In Experiment 3, the elevation at the paper tip compared to the middle part of the paper was within 5 mm.

In Example 4 in FIG. 9, the radius R1 of the fuser roller 51 was set to be 12.8 mm while the radius R2 of the pressure roller 52 was set to be 12.5 mm. The ASKER C hardness was set to be 40 degrees for both the fuser roller 51 and the pressure roller 52. The load applied between the two rollers was 3 kgf on one side. The nip 57 curved to be convex, bulging toward the fuser roller 51, and the approximate radius R3 of the nip 57 was 503 mm. The ratio of the approximate radius R3 of the nip 57 to the radius R2 of the pressure roller 52, namely, R3/R2, was 40.2.

Conditions of the surface temperature of the fuser roller 51 and the pressure roller 52 were set to be the same as those of Example 1. On the same conditions as Example 1, Experiment 1, 2 and 3 were performed.

In Experiment 1, no scraping mark made by the lower-side separation claw was observed on the sheet of paper. In Experiment 2, no paper tangling occurred for any of the five rounds of consecutive copying. In Experiment 3, the elevation at the paper tip compared to the middle part of the paper was 5 to 10 mm.

In Example 5 in FIG. 9, the radius R1 of the fuser roller 51 was set to be 13.5 mm while the radius R2 of the pressure roller 52 was set to be 12.5 mm. The ASKER C hardness of the fuser roller 51 was set to be 40 degrees while that of the pressure roller 52 was set to be 50 degress The load applied between the two rollers was 2 kgf on one side. The nip 57 curved to be convex, bulging toward the fuser roller 51, and the approximate radius R3 of the nip 57 was 16.0 mm. The ratio of the approximate radius R3 of the nip 57 to the radius R2 of the pressure roller 52, namely, R3/R2, was 1.28.

Conditions of the surface temperature of the fuser roller 51 and the pressure roller 52 were set to be the same as those of Example 1. On the same conditions as Example 1, Experiment 1, 2 and 3 were performed.

In Experiment 1, a slight scraping mark made by the lower side separation claw was observed on the sheet of paper. In Experiment 2, no paper tangling occurred for any of the five rounds of consecutive copying. In Experiment 3, the elevation at the paper tip compared to the middle part of the paper was within 5 mm.

In Example 6 in FIG. 9, the radius R1 of the fuser roller 51 and the radius R2 of the pressure roller 52 were set to be the same as Example 5. The ASKER C hardness of the fuser roller 51 and that of the pressure roller 52 were also set to be the same as those of Example 5. The load applied between the two rollers was 3 kgf on one side. The nip 57 curved to be convex, bulging toward the fuser roller 51, and the approximate radius R3 of the nip 57 was 17.2 mm. The ratio of the approximate radius R3 of the nip 57 to the radius R2 of the pressure roller 52, namely, R3/R2, was 1.38.

Conditions of the surface temperature of the fuser roller 51 and the pressure roller 52 were set to be the same as those of Example 1. On the same conditions as Example 1, Experiment 1, 2 and 3 were performed.

In Experiment 1, no scraping mark made by the lower-side separation claw was observed on the sheet of paper. In Experiment 2, no paper tangling occurred for any of the five rounds of consecutive copying. In Experiment 3, the elevation at the paper tip compared to the middle part of the paper was within 5 mm.

In Example 7 in FIG. 9, the radius R1 of the fuser roller 51 was set to be 12.5 mm and the radius R2 of the pressure roller 52 was set to be 12.5 mm, too. The ASKER C hardness of the fuser roller 51 was set to be 40 degrees while that of the pressure roller 52 was set to be 60 degrees. The load applied between the two rollers was 3 kgf on one side. The nip 57 curved to be convex, bulging toward the fuser roller 51, and the approximate radius R3 of the nip 57 was 16.5 mm. The ratio of the approximate radius R3 of the nip 57 to the radius R2 of the pressure roller 52, namely, R3/R2, was 1.32.

Conditions of the surface temperature of the fuser roller 51 and the pressure roller 52 were set to be the same as those of Example 1. On the same conditions as Example 1, Experiment 1, 2 and 3 were performed.

In Experiment 1, no scraping mark made by the lower-side separation claw was observed on the sheet of paper. In Experiment 2, no paper tangling occurred for any of the five rounds of consecutive copying. In Experiment 3, the elevation at the paper tip compared to the middle part of the paper was within 5 mm.

In Example 8 in FIG. 9, the radius R1 of the fuser roller 51 was set to be 12.5 mm and the radius R2 of the pressure roller 52 was set to be 12.5 mm, too. The ASKER C hardness was set to be 40 degrees for both the fuser roller 51 and the pressure roller 52. The load applied between the two rollers was 2 kgf on one side. The nip 57 became flat. The approximate radius R3 of the nip 57 was infinite. Therefore, the ratio of the approximate radius R3 of the nip 57 to the radius R2 of the pressure roller 52, namely, R3/R2, was also infinite.

Conditions of the surface temperature of the fuser roller 51 and the pressure roller 52 were set to be the same as those of Example 1. On the same conditions as Example 1, Experiment 1, 2 and 3 were performed.

In Experiment 1, no scraping mark made by the lower-side separation claw was observed on the sheet of paper. In Experiment 2, no paper tangling occurred for any of the five rounds of consecutive copying. In Experiment 3, the elevation at the paper tip compared to the middle part of the paper was 10 mm or more.

In Comparative Example 1 in FIG. 9, the radius R1 of the fuser roller 51 was set to be 13.5 mm while the radius R2 of the pressure roller 52 was set to be 12.5 mm. The ASKER C hardness was set to be 40 degrees for both the fuser roller 51 and the pressure roller 52. The load applied between the two rollers was 1 kgf on one side. The nip 57 curved to be convex, bulging toward the fuser roller 51, and the approximate radius R3 of the nip 57 was 14.0 mm. The ratio of the approximate radius R3 of the nip 57 to the radius R2 of the pressure roller 52, namely, R3/R2, was 1.12.

Conditions of the surface temperature of the fuser roller 51 and the pressure roller 52 were set to be the same as those of Example 1. On the same conditions as Example 1, Experiment 1, 2 and 3 were performed.

In Experiment 1, a remarkable scraping mark made by the lower-side separation claw was observed on the sheet of paper. In Experiment 2, paper tangling occurred for all of the five rounds of consecutive copying. In Experiment 3, the elevation at the paper tip compared to the middle part of the paper was within 5 mm.

In Comparative Example 2 in FIG. 9, the radius R1 of the fuser roller 51 was set to be 13.5 mm while the radius R2 of the pressure roller 52 was set to be 12.5 mm. The ASKER C hardness of the fuser roller 51 was set to be 40 degrees while that of the pressure roller 52 was set to be 50 degrees. The load applied between the two rollers was 1 kgf on one side. The nip 57 curved to be convex, bulging toward the fuser roller 51, and the approximate radius R3 of the nip 57 was 14.7 mm. The ratio of the approximate radius R3 of the nip 57 to the radius R2 of the pressure roller 52, namely, R3/R2, was 1.18.

Conditions of the surface temperature of the fuser roller 51 and the pressure roller 52 were set to be the same as those of Example 1. On the same conditions as Example 1, Experiment 1, 2 and 3 were performed.

In Experiment 1, a remarkable scraping mark made by the lower-side separation claw was observed on the sheet of paper. In Experiment 2, paper tangling occurred for all of the five rounds of consecutive copying. In Experiment 3, the elevation at the paper tip compared to the middle part of the paper was within 5 mm.

In Comparative Example 3 in FIG. 9, the radius R1 of the fuser roller 51 was set to be 12.5 mm and the radius R2 of the pressure roller 52 was set to be 12.5 mm, too. The ASKER C hardness of the fuser roller 51 was set to be 40 degrees while that of the pressure roller 52 was set to be 60 degrees. The load applied between the two rollers was 1 kgf on one side. The nip 57 curved to be convex, bulging toward the fuser roller 51, and the approximate radius R3 of the nip 57 was 13.5 mm. The ratio of the approximate radius R3 of the nip 57 to the radius R2 of the pressure roller 52, namely, R3/R2, was 1.08.

Conditions of the surface temperature of the fuser roller 51 and the pressure roller 52 were set to be the same as those of Example 1. On the same conditions as Example 1, Experiment 1, 2 and 3 were performed.

In Experiment 1, a remarkable scraping mark made by the lower-side separation claw was observed on the sheet of paper. In Experiment 2, paper tangling occurred for all of the five rounds of consecutive copying. In Experiment 3, the elevation at the paper tip compared to the middle part of the paper was within 5 mm.

In Example 9 in FIG. 11, the radius R1 of the fuser roller 51 was set to be 12.5 mm while the radius R2 of the pressure roller 52 was set to be 13.5 mm. The ASKER C hardness was set to be 40 degrees for both the fuser roller 51 and the pressure roller 52. The load applied between the two rollers was 2 kgf on one side. The nip 57 curved to be convex, bulging toward the pressure roller 52, and the approximate radius R3 of the nip 57 was 15.7 mm. The ratio of the approximate radius R3 of the nip 57 to the radius R2 of the fuser roller 51, namely, R3/R1, was 1.26.

The surface temperature of the heat roller was set at 200° C., to make the surface temperature of the fuser roller 51 and that of the pressure roller 52 be 170° C.

On the above conditions, in Experiment 1, an upper-side separation claw was provided to the fuser roller 51. A duplex copy of full-page, solid-black image was made on a sheet of paper. The sheet of paper was then checked manually whether it carried a scraping mark made by the upper-side separation claw or not.

In Experiment 2, the fuser roller 51 was not provided with an upper-side separation claw. Consecutive duplex copying of full-page, solid-black image to one hundred sheets of paper was repeated five rounds to check whether paper-tangling occurred on the fuser roller 51 or not.

In Experiment 1, a slight scraping mark made by the upper-side-separation claw was observed on the sheet of paper. In Experiment 2, paper tangling occurred once in five rounds of consecutive copying.

In Example 1 0 in FIG. 11, the radius R1 of the fuser roller 51 and the radius R2 of the pressure roller 52 were set to be the same as Example 9. The ASKER C hardness of the fuser roller 51 and that of the pressure roller 52 were also set to be the same as Example 9. The load applied between the two rollers was 3 kgf on one side. The nip 57 curved to be convex, bulging toward the pressure roller 52, and the approximate radius R3 of the nip 57 was 17.0 mm. The ratio of the approximate radius R3 of the nip 57 to the radius R1 of the fuser roller 51, namely, R3/R1, was 1.36.

Conditions of the surface temperature of the fuser roller 51 and the pressure roller 52 were set to be the same as those of Example 9. On the same conditions as Example 9, Experiment 1 and 2 were performed.

In Experiment 1, no scraping mark made by the upper-side-separation claw was observed on the sheet of paper. In Experiment 2, no paper tangling occurred in any of five rounds of consecutive copying.

In Example 1 1 in FIG. 11, the radius R1 of the fuser roller 51 was set to be 12.5 mm while the radius R2 of the pressure roller 52 was set to be 13.0 mm. The ASKER C hardness was set to be 40 degrees for both the fuser roller 51 and the pressure roller 52. The load applied between the two rollers was 3 kgf on one side. The nip 57 curved to be convex, bulging toward the pressure roller 52, and the approximate radius R3 of the nip 57 was 65.0 mm. The ratio of the approximate radius R3 of the nip 57 to the radius R1 of the fuser roller 51, namely, R3/RT, was 5.2.

Conditions of the surface temperature of the fuser roller 51 and the pressure roller 52 were set to be the same as those of Example 9. On the same conditions as Example 9, Experiment 1 and 2 were performed.

In Experiment 1, no scraping mark made by the upper-side separation claw was observed on the sheet of paper. In Experiment 2, no paper tangling occurred in any of five rounds of consecutive copying.

In Example 1 2 in FIG. 11, the radius R1 of the fuser roller 51 was set to be 12.5 mm while the radius R2 of the pressure roller 52 was set to be 12.8 mm. The ASKER C hardness was set to be 40 degrees for both the fuser roller 51 and the pressure roller 52. The load applied between the two rollers was 3 kgf on one side. The nip 57 curved to be convex, bulging toward the pressure roller 52, and the approximate radius R3 of the nip 57 was 503 mm. The ratio of the approximate radius R3 of the nip 57 to the radius R1 of the fuser roller 51, namely, R3/R1, was 40.2.

Conditions of the surface temperature of the fuser roller 51 and the pressure roller 52 were set to be the same as those of Example 9. On the same conditions as Example 9, Experiment 1 and 2 were performed.

In Experiment 1, no scraping mark made by the upper-side separation claw was observed on the sheet of paper. In Experiment 2, no paper tangling occurred in any of five rounds of consecutive copying.

In Example 1 3 in FIG. 11, the radius R1 of the fuser roller 51 was set to be 12.5 mm while the radius R2 of the pressure roller 52 was set to be 13.5 mm. The ASKER C hardness of the fuser roller 51 was set to be 50 degrees while that of the pressure roller 52 was set to be 40 degrees. The load applied between the two rollers was 2 kgf on one side. The nip 57 curved to be convex, bulging toward the pressure roller 52, and the approximate radius R3 of the nip 57 was 16.0 mm. The ratio of the approximate radius R3 of the nip 57 to the radius R1 of the fuser roller 51, namely, R3/R1, was 1.28.

Conditions of the surface temperature of the fuser roller 51 and the pressure roller 52 were set to be the same as those of Example 9. On the same conditions as Example 9, Experiment 1 and 2 were performed.

In Experiment 1, a slight scraping mark made by the upper-side separation claw was observed on the sheet of paper. In Experiment 2, no paper tangling occurred in any of five rounds of consecutive copying.

In Example 1 4 in FIG. 11, the radius R1 of the fuser roller 51 and the radius R2 of the pressure roller 52 were set to be the same as those of Example 1 3. The ASKER C hardness of the fuser roller 51 and that of the pressure roller 52 were set to be the same as those of Example 13, too. The load applied between the two rollers was 3 kgf on one side. The nip 57 curved to be convex, bulging toward the pressure roller 52, and the approximate radius R3 of the nip 57 was 17.2 mm. The ratio of the approximate radius R3 of the nip 57 to the radius R1 of the fuser roller 51, namely, R3/R1, was 1.38.

Conditions of the surface temperature of the fuser roller 51 and the pressure roller 52 were set to be the same as those of Example 9. On the same conditions as Example 9, Experiment 1 and 2 were performed.

In Experiment 1, no scraping mark made by the upper-side separation claw was observed on the sheet of paper. In Experiment 2, no paper tangling occurred in any of five rounds of consecutive copying.

In Example 1 5 in FIG. 11, the radius R1 of the fuser roller 51 was set to be 12.5 mm and the radius R2 of the pressure roller 52 was set to be 12.5 mm, too. The ASKER C hardness of the fuser roller 51 was set to be 60 degrees while that of the pressure roller 52 was set to be 40 degrees. The load applied between the two rollers was 3 kgf on one side. The nip 57 curved to be convex, bulging toward the pressure roller 52, and the approximate radius R3 of the nip 57 was 16.5 mm. The ratio of the approximate radius R3 of the nip 57 to the radius R1 of the fuser roller 51, namely, R3/R1, was 1.32.

Conditions of the surface temperature of the fuser roller 51 and the pressure roller 52 were set to be the same as those of Example 9. On the same conditions as Example 9, Experiment 1 and 2 were performed.

In Experiment 1, no scraping mark made by the upper-side separation claw was observed on the sheet of paper. In Experiment 2, no paper tangling occurred in any of five rounds of consecutive copying.

In Comparative Example 4 in FIG. 11, the radius R1 of the fuser roller 51 was set to be 12.5 mm while the radius R2 of the pressure roller 52 was set to be 13.5 mm. The ASKER C hardness was set to be 40 degrees for both the fuser roller 51 and the pressure roller. The load applied between the two rollers was 1 kgf on one side. The nip 57 curved to be convex, bulging toward the pressure roller 52, and the approximate radius R3 of the nip 57 was 14.0 mm. The ratio of the approximate radius R3 of the nip 57 to the radius R1 of the fuser roller 51, namely, R3/R1, was 1.12.

Conditions of the surface temperature of the fuser roller 51 and the pressure roller 52 were set to be the same as those of Example 9. On the same conditions as Example 9, Experiment 1 and 2 were performed.

In Experiment 1, a remarkable scraping mark made by the upper-side separation claw was observed on the sheet of paper. In Experiment 2, paper tangling occurred in all of five rounds of consecutive copying.

In Comparative Example 5 in FIG. 11, the radius R1 of the fuser roller 51 was set to be 12.5 mm while the radius R2 of the pressure roller 52 was set to be 13.5 mm. The ASKER C hardness of the fuser roller 51 was set to be 50 degrees while that of the pressure roller 52 was set to be 40 degrees. The load applied between the two rollers was 1 kgf on one side. The nip 57 curved to be convex, bulging toward the pressure roller 52, and the approximate radius R3 of the nip 57 was 14.7 mm. The ratio of the approximate radius R3 of the nip 57 to the radius R1 of the fuser roller 51, namely, R3/R1, was 1.18.

Conditions of the surface temperature of the fuser roller 51 and the pressure roller 52 were set to be the same as those of Example 9. On the same conditions as Example 9, Experiment 1 and 2 were performed.

In Experiment 1, a remarkable scraping mark made by the upper-side separation claw was observed. In Experiment 2, paper tangling occurred in all of five rounds of consecutive copying.

In Comparative Example 6 in FIG. 11 the radius R1 of the fuser roller 51 was set to be 12.5 mm and the radius R2 of the pressure roller 52 was set to be 12.5 mm, too. The ASKER C hardness of the fuser roller 51 was set to be 60 degrees while that of the pressure roller 52 was set to be 40 degrees. The load applied between the two rollers was 1 kgf on one side. The nip 57 curved to be convex, bulging toward the pressure roller 52, and the approximate radius R3 of the nip 57 was 13.5 mm. The ratio of the approximate radius R3 of the nip 57 to the radius R1 of the fuser roller 51, namely, R3/R1, was 1.08.

Conditions of the surface temperature of the fuser roller 51 and the pressure roller 52 were set to be the same as those of Example 9. On the same conditions as Example 9, Experiment 1 and 2 were performed.

In Experiment 1, a remarkable scraping mark made by the upper-side separation claw was observed on the sheet of paper. In Experiment 2, paper tangling occurred in all of five rounds of consecutive copying.

The above-mentioned examples of working of the present invention and comparative examples verified that the following conditions must be satisfied in order to achieve satisfactory performance of paper separation without depending on a separation claw. Namely, when the outer diameter of the fuser roller and that of the pressure roller are the same, the approximate radius of the nip formed between these two rollers is required to be equal to or greater than 1.25 times as large as the radius of the fuser roller or the pressure roller; and when the outer diameter of the fuser roller and the pressure roller are different, the approximate radius of the nip formed between both rollers is required to be equal to or greater than 1.25 times as large as the radius of either of the fuser roller or the pressure roller that has a smaller diameter.

While there has been described herein what are to be considered preferred embodiments of the present invention, other modifications and variations of the invention are possible to be practiced, provided all such modifications fall within the spirit and scope of the invention.

What is claimed is:

1. An image forming apparatus including a fusing device comprising:
a fuser roller for fusing a toner image on a sheet of paper;
a fuser-side external heating means for heating the fuser roller from an outside; and
a pressure roller getting into contact with the fuser roller to form a nip between them through which the sheet of paper passes; wherein
the fuser roller and the pressure roller have approximately a same outer diameter and are both composed of an elastic material; and
an approximate radius of the nip is set to be equal to or larger than 1.25 times as large as a radius of the fuser roller or the pressure roller.

2. An image forming apparatus as claimed in claim 1, wherein a convex line of the nip bulges toward the fuser roller.

3. An image forming apparatus as claimed in claim 1, wherein the fuser-side external heating means comprises a fuser-side heat roller having an internal heat source for heating the fuser roller by getting into contact with a fuser roller surface.

4. An image forming apparatus as claimed in claim 1, wherein the fuser-side external heating means comprises a plurality of fuser-side heat rollers each having an internal heat source for heating the fuser roller by getting into contact with a fuser roller surface.

5. An image forming apparatus as claimed in claim 1, wherein the elastic material composing the pressure roller has a higher hardness than the elastic material composing the fuser roller.

6. An image forming apparatus as claimed in claim 1, wherein the fuser roller is not provided with a separation claw which comes into contact with the fuser roller.

7. An image forming apparatus as claimed in claim 1, wherein the pressure roller is provided with a pressure-side external heating means for heating the pressure roller from an outside;

8. An image forming apparatus as claimed in claim 1, wherein the pressure roller is provided with a pressure-side external heating means for heating the pressure roller from an outside, and the pressure-side external heating means comprises a pressure-side heat roller having an internal heat source for heating the pressure roller by getting into contact with a pressure roller surface.

9. An image forming apparatus including a fusing device comprising:
a fuser roller for fusing a toner image on a sheet of paper;
a fuser-side external heating means for heating the fuser roller from an outside; and
a pressure roller getting into contact with the fuser roller to form a nip between them through which the sheet of paper passes; wherein
the fuser roller and the pressure roller have different outer diameters and are both composed of an elastic material; and
an approximate radius of the nip is set to be equal to or larger than 1.25 times as large as a radius of either the fuser roller or the pressure roller with smaller outer diameter.

10. An image forming apparatus as claimed in claim 9, wherein the pressure roller has smaller outer diameter than the fuser roller.

11. An image forming apparatus as claimed in claim 9, wherein a convex line of the nip bulges toward the fuser roller.

12. An image forming apparatus as claimed in claim 9, wherein the fuser-side external heating means comprises a fuser-side heat roller having an internal heat source for heating the fuser roller by getting into contact with a fuser roller surface.

13. An image forming apparatus as claimed in claim 9, wherein the fuser-side external heating means comprises a plurality of fuser-side heat rollers each having an internal heat source for heating the fuser roller by getting into contact with a fuser roller surface.

14. An image forming apparatus as claimed in claim 9, wherein the elastic material composing the pressure roller has a higher hardness than the elastic material composing the fuser roller.

15. An image forming apparatus as claimed in claim 9, wherein the fuser roller is not provided with a separation claw which comes into contact with the fuser roller.

16. An image forming apparatus as claimed in claim 9, wherein the pressure roller is provided with a pressure-side external heating means for heating the pressure roller from an outside;

17. An image forming apparatus as claimed in claim 1, wherein the pressure roller is provided with a pressure-side external heating means for heating the pressure roller from an outside, and the pressure-side external heating means comprises a pressure-side heat roller having an internal heat source for heating the pressure roller by getting into contact with a pressure roller surface.
